(19) United States
(12) Patent Application Publication
(10) Pub. No.: US 2007/0198229 A1
(43) Pub. Date: Aug. 23, 2007

(54) Method for processing a signal

(75) Inventors: Rupert Maier, Eggolshiem (DE); Ralf Sykosch, Weilersbach (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 10/598,849

(22) PCT Filed: Mar. 15, 2005
(86) PCT No.: PCT/EP05/51156

§ 371 Date: Sep. 13, 2006

(30) Foreign Application Priority Data
Mar. 15, 2004 (DE) 10 2004 012 505.8

(51) Int. Cl. G06F 15/00

(52) U.S. Cl. 702/198

(57) ABSTRACT

During a method for processing a signal (S(A)), which reproduces a physical output quantity (A), of an industrial installation (4), an output signal (S(Z)), which reproduces a derived physical target quantity (Z), is ascertained from the signal (S(A)). To this end, an automatic conversion of the unit of the output quantity (A) into a target unit (ZE) of the target quantity (Z) is carried out.

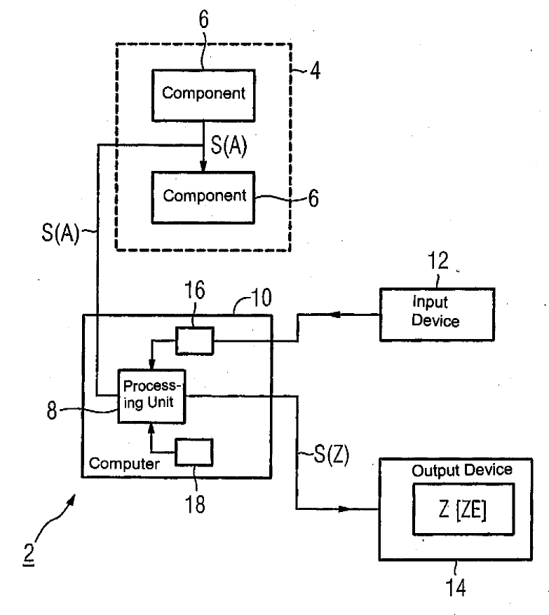

The invention relates to a method for processing at least one signal, reproducing a physical output quantity, of an industrial installation.

In an industrial installation, for example in the paper or metal industry, in rolling mills, in plants for energy generation, in the automobile industry or in the chemical industry, signals are continuously generated during the industrial process and supplied to an evaluating unit. The signals provide information about the properties characterizing the installation process. These are, for example, the temperature of an installation component or of an operating means or other fluid, the rotational speed of a shaft, the length of the feed travel of a processing machine etc. The signals delivered by the industrial installation, therefore, reproduce a physical output quantity. This is composed of a value, for example the speed value, and a physical unit. Physical output quantity is generally understood to be the properties of a physical and chemical nature characterizing an installation process.

In the case of installation components used throughout the world, the problem is that different physical units are normally used in different countries. The output quantities forming the basis of the output signals must therefore be represented in different units.

There is also the problem that for monitoring or evaluating an installation process, for example in the case of a fault, physical quantities are needed which are not provided directly via the signals of the installation. Instead, the physical quantities needed must first be converted into a target quantity from the output quantity transmitted with the signal. Thus, for example, from the rotational speed of a roller the frequency, that is to say the number of revolutions of the roller per unit time, must be calculated for the evaluation. The evaluation and diagnosis of industrial installation processes are frequently performed by means of mobile diagnostic and control systems. As a rule, these are very flexible with regard to the possible evaluations and need to be operated by trained personnel. Such a mobile diagnostic system, for example, reads out the signals of an installation process and creates an evaluation with the aid of a calculation formula. The calculation formula is in some cases input manually by operating personnel, i.e. the operating personnel creates case-related evaluation programs for evaluating the installation process.

The invention is based on the object of simplifying the determination of a derived target quantity from a physical output quantity.

According to the invention, the object is achieved by a method for processing at least one signal of an industrial installation which reproduces a physical output quantity. From the output quantity, which is composed of a value and of a unit, an output signal is determined or calculated which reproduces a derived physical target quantity which, in turn, consists of a value and of a corresponding target unit. To determine the target quantity, an automatic conversion of the unit of the output quantity into the target unit of the target quantity is provided.

In comparison with the previously used and necessary manual conversion, the automatic conversion and determination of the unit of the target quantity eliminates an error source. The error probability is reduced, in particular, with a diagnosis or evaluation of an installation process in which target quantities derived from the signals provided by the installation are utilized for the evaluation. The target quantity and the output quantity can be based on the same type of units, for example a measure of length. In the simplest case, therefore, the output quantity is only converted into another unit. As an alternative, however, the conversion can be based on very complex calculations in which a multiplicity of output quantities, constants and other parameters are used for determining the target quantity.

According to an appropriate development, the conversion into the target unit is performed with the aid of a table in which the conversion parameters necessary for converting the units in question are deposited. Since the conversion is performed on the basis of a universal table, that is to say a single table, which is utilized equally for all units, the automatic determination of the target unit is independent of the actual individual case and can be used, therefore, in a simple and inexpensive manner for any requirements.

To create this universal table, it is provided that the units are broken down into basic SI units. This measure ensures simple and reliable conversion by way of the basic SI units to which all units can be reduced. The conversion can be in any direction, for example from a non-SI unit into an SI unit or, conversely, from a non-SI unit into another non-SI unit or into an SI unit derived from the basic SI units. Such an SI unit derived from the basic SI units is, for example, the Newton N unit which can be broken down into the basic SI unit kilogram kg, meter m and second s.

The various units are suitably arranged underneath one another in a column of the table and in the row for the respective unit, the parameters necessary for the break-down into basic SI units are listed column by column.

For the break-down into the basic SI units, the following formula is preferably used:
x[E]=(y[SI]*f*b^{e}*+c)*Πᵢ[SI]ᵢ^{e[SI]}^{ᵢ}
where:
x is the value of the physical quantity in the unit [E],
y is the value of the physical quantity in the basic SI unit,
f is a conversion factor,
b,e is the base and the exponent with which the conversion factor f is weighted,
c is a constant (offset),
Π[SI]ᵢ^{e[SI]}^{ᵢ} is the product sum of the basic SI units weighted with the exponent e[SI] allocated in each case, where i is a running index.

On the basis of this formula, any physical unit can be resolved and converted into the associated basic SI unit with the aid of the table, for example miles into meters, Celsius into Kelvin etc. Using this formula, all physical quantities can be universally converted into basic SI units.

According to a preferred development, particularly in the case of a complex calculation formula for determining the target quantity, the units of the physical quantities included in the calculation formula are in each case converted into basic SI units and the target quantity is specified in the desired target unit. This target unit can deviate from the basic SI units and be a derived SI unit or also a non-SI unit. Depending on the desired form of representation, the user has the possibility, therefore, of specifying the target unit, and thus the desired output format.

The calculation formula is input, in particular, by the operating personnel for diagnostic and monitoring purposes. This can be done once so that the formula can be used time and again for future diagnoses. As an alternative, a suitable calculation formula is manually input by the operating personnel in every individual case. Manual input of the calculation formula provides for a very flexible evaluation of the output quantities, on the one hand. At the same time, the automatic determination of the target unit reduces an error source, namely the choice of a wrong unit.

Furthermore, a plausibility check is suitably performed by means of the automatically determined target unit as to whether the calculation formula input by the operating personnel can be correct. For this purpose, the physical quantities included in the calculation formula are resolved into their basic SI units so that the target unit is available in basic SI units, at least at first. In the second step, a check is then made as to whether this target unit determined on the basis of the calculation formula is a meaningful unit and is deposited, for example, in the table. If it is not deposited, an error signal is generated. As an alternative, the user predetermines the desired target unit and an automatic check is made whether the target unit broken down into basic SI units matches the basic SI units determined via the calculation formula.

To obtain as uniform a display and output format as possible, it is appropriately provided that the target quantity, that is to say the calculated value together with the target unit, is displayed in accordance with a predetermined standard. In this context, it is specified, for example, whether the representation is in the powers of ten notation or by means of suitable SI prefixes. In the case of a length measure, for example, it can be preset that millimeters are represented as “mm” or also as “10⁻³ m”. For this purpose, a table is preferably also stored in which the correlation between the powers of ten and the SI prefixes and possibly the usual names can be found.

The automatic conversion of the units described is preferably used for a mobile diagnostic and evaluating system with the aid of which the signal in question is read out in the active operation of an industrial process and the output quantity is generated with the desired target unit.

An exemplary embodiment of the invention will be explained in greater detail with reference to the single figure. The figure shows in a diagrammatic, greatly simplified representation a block diagram of an evaluating unit coupled to an installation process.

The automatic determination of the target units is explained with reference to an, in particular, mobile diagnostic or evaluation system 2 which is temporarily connected to an industrial installation 4. However, the automatic determination of the target unit is not restricted to this application.

Within the installation 4, a multiplicity of components 6 are usually arranged which exchange data with one another. These components 6 are, in particular, processing machines and measuring and monitoring devices. Between the components 6, signals S (A) are exchanged which reproduce physical output quantities A of the processes running on the respective component. Such a physical quantity is, for example, the rotational speed of a shaft, the magnitude of a supply current or of a supply voltage, the temperature of a workpiece, of an operating means or other fluid, the concentration of a substance etc.

To improve and optimize the installation process, but also for fault finding and diagnosis, it is often required to perform an evaluation of the processes running in the installation. In the exemplary embodiment, the mobile diagnostic or evaluating system 2 is connected to the installation process for this purpose. To be precise, the evaluating system 2 picks up the signal S(A) and transfers it to an evaluating unit 8 of a data processing device (computer) 10. The latter is connected to an input device 12 and to an output device 14.

Within a command module 16, the inputs determined via the input device 12 are transferred to the evaluating unit 8 as computing input for processing and converting the output quantity A. These inputs can be simple instructions or also complex sequence programs in which a calculation formula for converting the output quantity into the target quantity, possibly by using other quantities, is implemented. To determine the target quantity Z, the evaluating unit 8 also retrieves information from a table deposited in a data memory 18.

Taking into consideration the calculation input from the command module 16 and the information deposited in the table, the evaluating unit 8 determines the target quantity Z and delivers an output signal S(Z) to the subsequent output unit 14 on which the target quantity Z[ZE] is output in the desired target unit [ZE]. The output unit 14 is, for example, a monitor or a printer.

During this process, the unit of the output quantity A is automatically converted into a target unit [ZE] of the target quantity Z in the evaluating unit 8. For this purpose, the unit of the output quantity A is first broken down into its basic SI units, wherein the respective value of the output quantity A is weighted with a conversion factor and possibly with a constant c in accordance with the conversion of the units.

The value of the respective physical quantity in the respective unit

[E] is determined in accordance with the following formula:
x[E]=(y[SI]*f*b^{e}+c)*Πᵢ[SI]ᵢ^{e[SI]}^{ᵢ}
where y [SI] is the value in the basic SI unit, f is a factor and b^{e} is a weighting factor (b=base, e=exponent) for the factor f. The product f*b^{e} is the conversion factor. c is a constant which, for example, specifies a shift or an offset for the conversion between two units. To form the unit, a product of the basic SI units is formed according to Πᵢ[SI]ᵢ^{e[SI]}^{ᵢ} for determining the correct representation of basic units. i is a running index for table columns, in the column head of which the basic units and in the rows of which the respective exponents for the basic units are reproduced. The individual parameters listed in the above formula are deposited for all units, at least for all units of interest, in the table.

An example of such a table is shown in the text which follows. In the table, different units and their break-down into basic SI units are listed row by row. In the first column, the type of physical quantity is specified, the second column specifies the formula symbol normally used, in the third column, the abbreviation of the unit is listed and in the other columns, the individual parameters for the break-down into the basic SI units are listed. One column is in each case provided for the factor f, the base b, the exponent e and the constant c. In the other columns, the symbol of the basic SI units and the in each case associated basic SI unit are listed in the column header. In the individual rows, the exponents are then listed with which the respective basic SI unit must be weighted in order to obtain the correct representation of basic SI units.

| [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|
| Work, energy | W | Watt | | | | | | | | | | | |
| Acceleration | a | m/s² | 1.0 | 1 | 1 | 0.0 | 0 | 1 | −2 | 0 | 0 | 0 | 0 |
| Rotational | n | Revolution/sec, | 1.0 | 1 | 1 | 0.0 | 0 | 0 | −1 | 0 | 0 | 0 | 0 |
| speed | | rps | | | | | | | | | | | |
| | | Revolution/ | 1.666667 | 10 | −2 | 0.0 | 0 | 0 | −1 | 0 | 0 | 0 | 0 |
| | | minute, rpm | | | | | | | | | | | |
| Pressure | P | Pascal, Pa | 1.0 | 1 | 1 | 0.0 | 1 | −1 | −2 | 0 | 0 | 0 | 0 |
| | | Bar, bar | 1.0 | 10 | 5 | 0.0 | 1 | −1 | −2 | 0 | 0 | 0 | 0 |
| Area | A | m² | 1.0 | 1 | 1 | 0.0 | 0 | 2 | 0 | 0 | 0 | 0 | 0 |
| Frequency | f | Hertz; Hz | 1.0 | 1 | 1 | 0.0 | 0 | 0 | −1 | 0 | 0 | 0 | 0 |
| Speed, | v | m/s | 1.0 | 1 | 1 | 0.0 | 0 | 1 | −1 | 0 | 0 | 0 | 0 |
| velocity | | | | | | | | | | | | | |
| Force | F | Newton, N | 1.0 | 1 | 1 | 0.0 | 1 | 1 | −2 | 0 | 0 | 0 | 0 |
| Moment, | M | Newtonmeter, Nm | 1.0 | 1 | 1 | 0.0 | 1 | 2 | −2 | 0 | 0 | 0 | 0 |
| torque | | | | | | | | | | | | | |
| Circular frequency | ω | 1/s | 1.0 | 1 | 1 | 0.0 | 0 | 0 | −1 | 0 | 0 | 0 | 0 |
| Length | l | m | 1.0 | 1 | 1 | 0.0 | 0 | 1 | 0 | 0 | 0 | 0 | 0 |
| | | inch, in | 2.54 | 10 | −2 | 0.0 | 0 | 1 | 0 | 0 | 0 | 0 | 0 |
| | | mile, mi | 1,609344 | 10 | 3 | 0.0 | 0 | 1 | 0 | 0 | 0 | 0 | 0 |
| | | yard, yd | 0.9144 | 1 | 1 | 0.0 | 0 | 1 | 0 | 0 | 0 | 0 | 0 |
| Mass | m | kilogram, kg | 1.0 | 1 | 1 | 0.0 | 1 | 0 | 0 | 0 | 0 | 0 | 0 |
| | | gram, g | 1.0 | 10 | −3 | 0.0 | 1 | 0 | 0 | 0 | 0 | 0 | 0 |
| | | tonne, t | 1.0 | 10 | 3 | 0.0 | 1 | 0 | 0 | 0 | 0 | 0 | 0 |
| Electrical | U | Volts, V | 1.0 | 1 | 1 | 0.0 | 1 | 2 | −3 | −1 | 0 | 0 | 0 |
| tension | | | | | | | | | | | | | |
| Electrical current | I | Ampere, A | 1.0 | 1 | 1 | 0.0 | 0 | 0 | 0 | 1 | 0 | 0 | 0 |
| intensity | | | | | | | | | | | | | |
| Electrical current | J | A/m² | 1.0 | 1 | 1 | 0.0 | 0 | −2 | 0 | 1 | 0 | 0 | 0 |
| density | | | | | | | | | | | | | |
| Temperature | T | Kelvin, K | 1.0 | 1 | 1 | 0.0 | 0 | 0 | 0 | 0 | 1 | 0 | 0 |
| | | Degrees, Celsius | 1.0 | 1 | 1 | −273.15 | 0 | 0 | 0 | 0 | 1 | 0 | 0 |
| | | ° C. | | | | | | | | | | | |
| Rotational | n | Revolution/ | 1.0 | 1 | 1 | 0.0 | 0 | 0 | −1 | 0 | 0 | 0 | 0 |
| frequency | | second, | | | | | | | | | | | |
| | | rps | | | | | | | | | | | |
| Volume | V | m³ | 1.0 | 1 | 1 | 0.0 | 0 | 3 | 0 | 0 | 0 | 0 | 0 |
| Amount of heat | Q | J | 1.0 | 1 | 1 | 0.0 | 1 | 2 | −2 | 0 | 0 | 0 | 0 |
| Electrical | R | Ohms, Ω | 1.0 | 1 | 1 | 0.0 | 1 | 2 | −3 | −1 | 0 | 0 | 0 |
| resistance | | | | | | | | | | | | | |
| Angular | α | rad/s², 1/s² | 1.0 | 1 | 1 | 0.0 | 0 | 0 | −2 | 0 | 0 | 0 | 0 |
| acceleration | | | | | | | | | | | | | |
| Angular | ω | rad/s, 1/s | 1.0 | 1 | 1 | 0.0 | 0 | 0 | −1 | 0 | 0 | 0 | 0 |
| velocity | | | | | | | | | | | | | |
| Time | t | Second, s | 1.0 | 1 | 1 | 0.0 | 0 | 0 | 1 | 0 | 0 | 0 | 0 |
| | | Minute, m | 60.0 | 1 | 1 | 0.0 | 0 | 0 | 1 | 0 | 0 | 0 | 0 |
| | | Hour, h | 3600.0 | 1 | 1 | 0.0 | 0 | 0 | 1 | 0 | 0 | 0 | 0 |
| | | Day, d | 86400.0 | 1 | 1 | 0.0 | 0 | 0 | 1 | 0 | 0 | 0 | 0 |

Using this table, it is possible to break down any units into their basic SI units. Thus, for example, the table directly shows the break-down for the unit “inch”:
x[inch]=(y*2.54*10⁻²+0)*kg⁰*m¹*s⁰*A⁰*K⁰*mol^{0*cd}⁰

The desired target unit [ZE] can be easily and automatically formed from any output units by breaking them down into the basic SI units with the aid of this universal table, be it a basic SI unit, an SI unit derived from this or a non-SI unit since all units can be reduced to the basic SI units in the manner shown in the formula, and displayed.

The automatic conversion into the desired target unit provides for distinct simplification since in some cases complex conversions between different units must be taken into consideration. It is thus possible in a simple manner to specify a physical quantity in different output units, for example in accordance with different country standards. Furthermore, the automatic conversion provides considerable support for the work of the diagnostic personnel if, for example, the output quantities A are not represented in SI units due to the country-related settings.

The automatic determination of the target unit also provides for a plausibility check in a particularly simple manner. Thus, the evaluating system 2 checks whether the target unit [ZE] determined actually corresponds to a known physical quantity. If this is not the case, a corresponding error message is output, for example on the output unit 14. This aid thus provides a simple plausibility check for checking calculation formulae.

Furthermore, a standardized output of the target quantity is provided with this system in a simple manner. For example, the user inputs the desired output format, whether certain units are to be used, for example for certain groups of countries, or whether the representation as powers of ten or, as an alternative, a prefix for the SI unit characterizing the powers of ten is to be selected. For the latter, the further table following is preferably deposited in the data memory 18, in which in each case the power of ten, the abbreviation allocated to the power of ten and the sign are in each case listed as prefix for the SI unit in rows.

| Power | Name | Symbol |
|---|---|---|
| 10²⁴ | Yotta | Y |
| 10²¹ | Zetta | Z |
| 10¹⁸ | Exa | E |
| 10¹⁵ | Peta | P |
| 10¹² | Tera | T |
| 10⁹ | Giga | G |
| 10⁶ | Mega | M |
| 10³ | Kilo | k |
| 10² | Hecto | h |
| 10¹ | Deca | da |
| 10⁻¹ | Deci | d |
| 10⁻² | Centi | c |
| 10⁻³ | Milli | m |
| 10⁻⁶ | Micro | μ |
| 10⁻⁹ | Nano | n |
| 10⁻¹² | Pico | p |
| 10⁻¹⁵ | Femto | f |
| 10⁻¹⁸ | Atto | a |
| 10⁻²¹ | Zepto | z |
| 10⁻²⁴ | Yocto | y |

1-10. (canceled)

11. A method for processing at least one signal representing a physical output quantity in an industrial installation, comprising the steps of:
receiving the at least one signal representing the physical output quantity;
determining an output signal representing a derived physical target quantity from the at least one signal, said target quantity having a target unit; and
automatically converting a unit of the physical quantity into the target unit of the target quantity.

12. The method of claim 11, wherein the converting step includes the step of considering a table in which conversion factors necessary for converting the unit of the at least one signal are deposited.

13. The method claim 12, wherein the units in the table are broken down into basic SI units.

14. The method of claim 13, wherein various units are arranged underneath one another in a column and conversion parameters for breaking down a unit in the table into a basic SI units are listed column by column in rows.

15. The method of claim 13, wherein the break-down into a basic SI unit is effected with the aid of the formula
x[E]=(y[SI]*f*b^{e}*+c)*Πᵢ[SI]ᵢ^{e[SI]}^{ᵢ}
wherein x is the value of the physical quantity in the unit [E], y is the value of the physical quantity in a basic SI unit, f is the conversion factor, b is the base and e is the exponent of the base b with which the conversion factor is weighted, c is an offset constant, i is a running index and Πᵢ[SI]ᵢ^{e[SI]}^{ᵢ} is the product sum of basic SI units that are each weighted with a respective exponent e[SI].

16. The method of claim 12, further comprising the steps of:
including the unit of the physical quantity in a calculation formula,
converting the unit of the physical quantity into a basic SI unit for determining the target quantity, and
specifying the target quantity in a desired target unit.

17. The method of claim 11, further comprising the step of inputting a calculation formula for determining the target quantity.

18. The method of claim 17, further comprising the step of automatically subjecting the calculation formula to a plausibility check using the target unit.

19. The method of claim 11, further comprising the step of displaying the target quantity in accordance with a predetermined standard.

20. The method of claim 11, further comprising the steps of detecting the at least one signal from an active operation in an industrial process using a mobile diagnostic and evaluating system, and generating the target quantity with the help of the system.
